(19) United States
(12) Patent Application Publication
(10) Pub. No.: US 2005/0111912 A1
(43) Pub. Date: May 26, 2005

(54) Locking mechanism

(76) Inventors: Simon Brain, Huntersville, NC (US); Jamie Cress, Concord, NH (US)

Correspondence Address: Samuels, Gauthier & Stevens, LLP;Attn: Maurice E. Gauthier, Suite 3300, 225 Franklin Street, Boston, MA, 02110, US

(21) Appl. No.: 10/720,874

(22) Filed: Nov. 24, 2003

(51) Int. Cl. B25G 3/00

(52) U.S. Cl. 403/353

(57) ABSTRACT

In a modular frame assembly having horizontal beams with support lugs received and interlocked in holes in vertical posts, brackets on the beams have pins that snap into one of the post holes to prevent unintended dislocation of the beams from the posts.

### BACKGROUND OF THE INVENTION

1. Field of the Invention

This invention relates to a locking mechanism for preventing unintended disconnection of generally horizontal beams from vertical support posts in a modular frame assembly.

2. Description of the Prior Art

In a typical modular frame assembly, as shown for example in FIGS. 8 and 9, horizontal beams 10 are supported by posts 12. The beams are vertically spaced to provide storage bays for packaged goods 14 that are typically carried on pallets 16. The ends of the beams are adjustably connected to their respective posts by angle brackets 18 having flanges 20 with support lugs 22 projecting from their front faces. As shown for example in FIG. 2, the support lugs 22 have reduced diameter stems 24 terminating in enlarged heads 26.

The posts 12 are provided with vertically spaced and vertically elongated holes or first openings 28. The upper enlarged portions of the holes are sized to axially receive the enlarged lug heads 26. When the lugs are thus inserted, the beams can then be lowered, resulting in a mechanical interconnection of the lug heads in the narrower lower portions of the holes 28. The beams maybe removed for repositioning by reversing these steps, i.e., by raising the beams to realign the lug heads with the wider upper portions of the post holes, followed by axially retraction of the lugs from the post holes.

With this type of arrangement, there is a danger that the beams may become accidentally dislodged by an unintended exertion of upward force. This can occur, for example, when a loaded pallet 16 in a lower storage bay is raised against the supporting beam of an upper storage bay.

The objective of the present invention is to prevent the beams from being accidentally dislodged by providing the angle brackets 18 with locking mechanisms that prevent the lug heads 26 from being realigned with the wider upper portions of the post holes 28 after the lugs have been lowered to their interlocked positions.

### SUMMARY OF THE INVENTION

In accordance with the present invention, each bracket flange is provided with an access opening above one of the support lugs. An elongated resilient plate is secured at opposite ends to a back face of the bracket flange. The mid portion of the plate carries a locking pin projecting through the access opening and beyond the front face of the bracket flange. The plate is resiliently deflectable to accommodate retraction of the pin into the access opening as the lugs are inserted into the widened upper portions of the post holes. As the lugs are lowered into their interlocked positions, the locking pin snaps into the post hole of the adjacent lug, thus preventing that lug (as well as the other lugs) from being raised into realignment with the widened upper portions of the post holes.

Other features and advantages of the present invention will now be described in greater detail with reference to the accompanying drawings, wherein:

### BRIEF DESCRIPTION OF THE DRAWINGS

FIG. 1 is a perspective view of one end of a beam attached to a support post and restrained from accidental disengagement by a locking mechanism is accordance with the present invention;

FIG. 2 is an exploded perspective view of the locking mechanism;

FIG. 3 is a sectional view on an enlarged scale taken along line 3-3 of FIG. 1;

FIG. 4 is a sectional view similar to FIG. 3 showing the locking pin interfering with vertical movement of the flange and its lugs in relation to the support post;

FIG. 5 is a view similar to FIGS. 3 and 4 showing the resilient plate in a deflected condition with the locking pin retracted into its access opening;

FIG. 6 is a perspective view showing the use of a tool to manually deflect the resilient plate;

FIG. 7 is a view again similar to FIGS. 3-5 and showing the beam end flange separated from the support post;

FIG. 8 is a perspective view of a typical modular frame assembly; and

FIG. 9 is a perspective view showing a conventional beam end in both a connected and removed condition.

### DETAILED DESCRIPTION OF PREFERRED EMBODIMENT

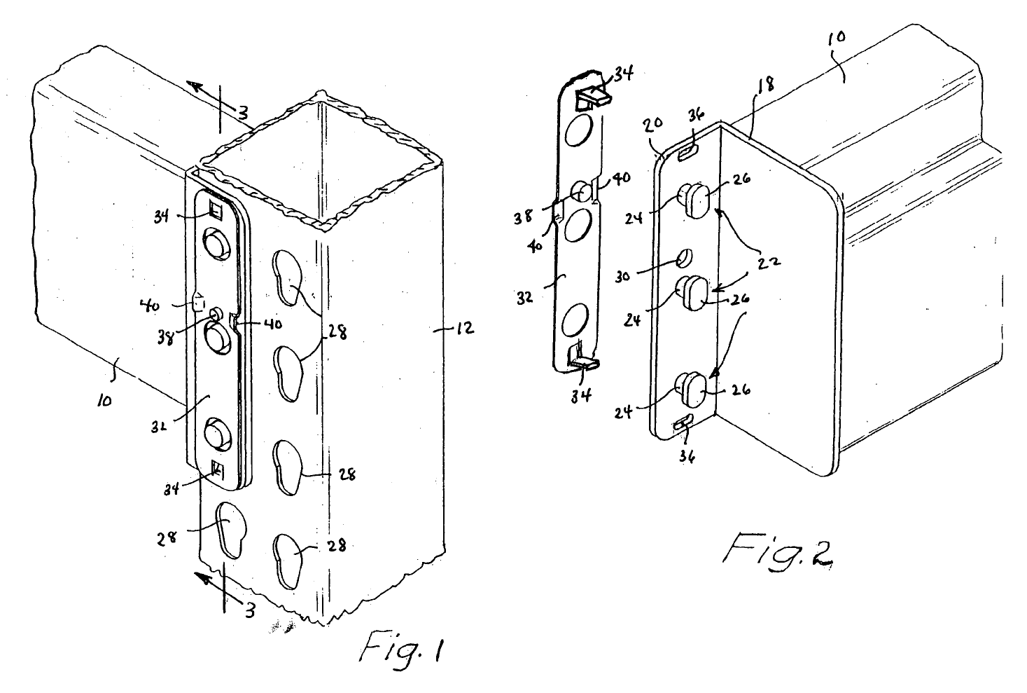

With reference initially to FIGS. 1-3, a second access opening 30 is located above one of the support lugs 22. An elongated resilient plate 32 is attached to the back face of the flange 20. Attachment of the plate 32 is achieved by integral tabs 34 received in and bent over into mechanical interengagement in slots 36 in the flange 20. A locking pin 38 projects from a mid-portion of the plate 32 through the access opening 30 and beyond the front face of the flange 20.

As shown in FIG. 5, when mounting the beam 10 on its support posts 12, the lugs 22 are initially axially inserted into the upper widened portions of the holes 28. At this stage, the locking pin 38 is in engagement with the post, causing the pin to be pushed back into its access opening 30 as the mid portion of the plate 32 is deflected rearwardly. Rearward plate deflection is accommodated by a slight shifting of one or both tabs 34 in their respective slots 36.

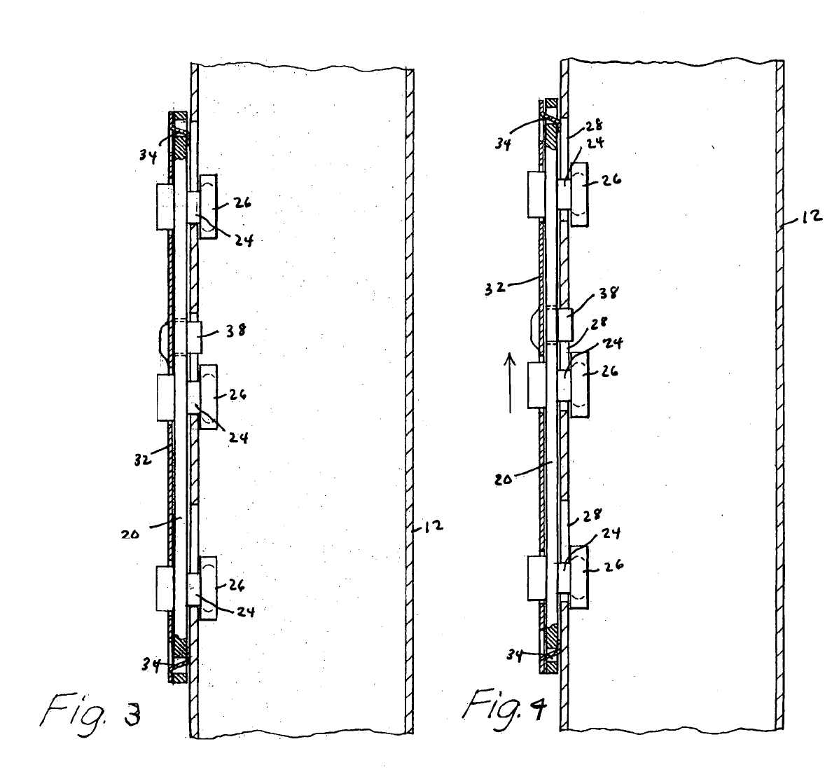

When the beam 10 is then lowered to the position shown in FIG. 3, the enlarged heads 26 of the lugs 22 are interlocked in the narrower lower portions of the post holes 28, and the pin 38 is snapped into the post hole of its adjacent lug.

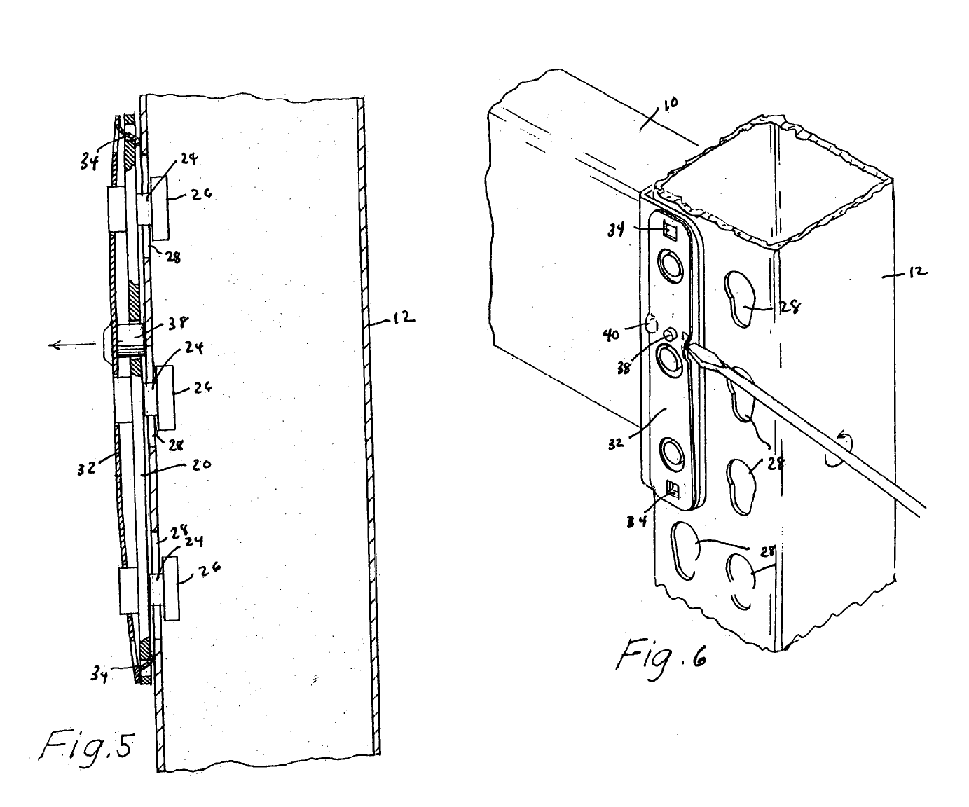

Thus, as shown in FIG. 4, any attempt to raise the beam from its interlocked position will be blocked by engagement of the pin 38 with the upper edge of the post hole in which it is seated.

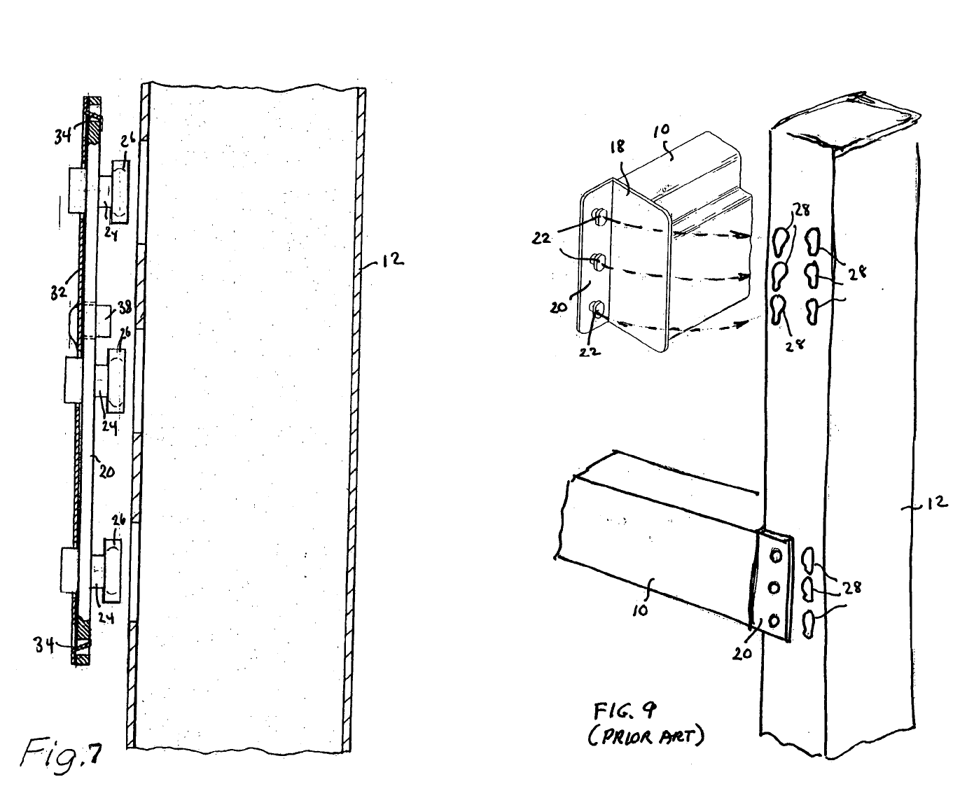

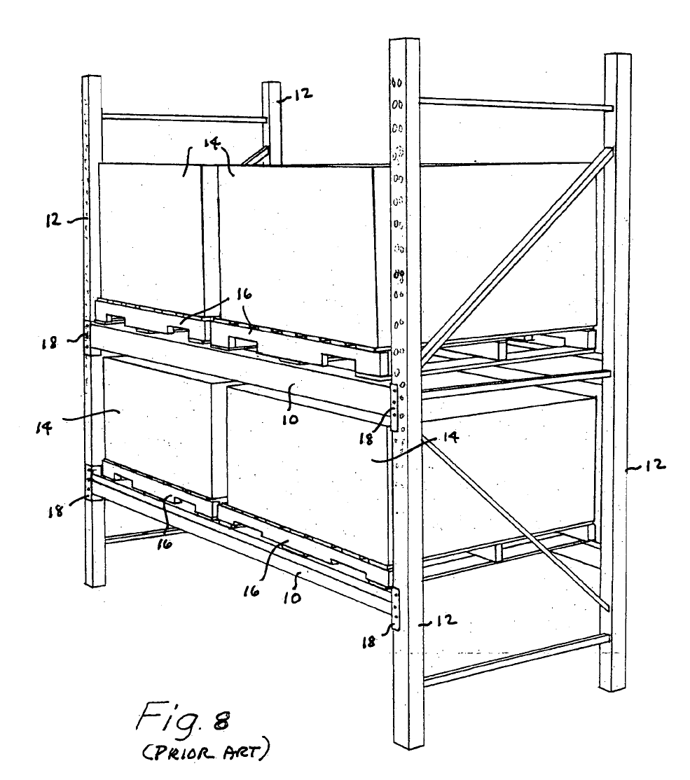

To facilitate disengagement of the beam from the support posts, the plate 32 is provided with at least one and preferably two oppositely facing peripheral notches 40 aligned laterally with the locking pin 38. The notches 40 coact with the back face of the flange 20 to provide pockets which, as shown in FIG. 6, can be accessed by a screw driver or the like to manually deflect the plate 20 to withdraw the locking pin 38 into its access opening 30 and thus permit intentional removal of the beam 10 from its support posts 12.

In light of the foregoing, it will now be appreciated by those skilled in the art that the locking mechanism of the present invention offers important features and advantages. Among these is the simplicity of it construction comprising a single resilient plate and associated projecting locking pin. The plate is anchored at both ends on opposite sides of the locking pin, thus providing a rugged assembly that resists damage. Plate deflection is limited by the movement of the tabs 34 within their respective slots 26, and by the inherent tensile strength of the plate. Thus, excessive bending and damaging permanent plate distortion is avoided. The plate is readily manually deflected when necessary to accommodate intentional removal and repositioning of the beams.

1. A locking mechanism for preventing unintended disconnection of a generally horizontal beam from a vertical support post, said post having an array of vertically elongated first openings overlapped by an end flange on said beam, with lugs projecting from a front face of said flange into said first openings, said beam and flange being vertically shiftable between a raised position at which said lugs are freely moveable into and out of upper portions of said first openings, and a lowered position at which said lugs are interlocked with said post in lower portions of said first openings, said locking mechanism comprising:
a second opening in said flange above one of said lugs;
a resilient plate;
connecting means on opposite sides of a mid-portion of said plate for securing said plate to a back face of said flange; and
a pin projecting from the mid-portion of said plate through said second opening and beyond a front face of said flange, said plate being resiliently deflectable to accommodate retraction of said pin into said second opening when said lugs are aligned with the upper portions of said first openings, and to urge said pin into the upper portion of one of said first openings when said lugs are shifted to the lower portions of said first openings.

2. The locking mechanism of claim 1 wherein said connecting means comprises tabs on said plate, said tabs being received in and deformed into interlocked engagement within slots in said flange.

3. The locking mechanism of claim 2 wherein said tabs are movable within said slots to accommodate deflection of said plate relative to said flange.

4. The locking mechanism, in accordance with any one of claims 1-3 wherein said plate is provided with at least one peripheral deformation configured to coact with the back face of said flange in defining a pocket for receiving a tool used to resiliently deflect the plate in order to withdraw said pin into said access opening.

5. The locking mechanism in accordance with claim 4 wherein said at least one peripheral deformation is aligned laterally with said pin.
